(19) United States
(12) Patent Application Publication
(10) Pub. No.: US 2012/0287352 A1
(43) Pub. Date: Nov. 15, 2012

(54) LIGHTING DEVICE, DISPLAY DEVICE AND TELEVISION RECEIVER

(75) Inventor: Yoshiki Takata, Osaka-shi (JP)

(73) Assignee: SHARP KABUSHIKI KAISHA, Osaka-shi, Osaka (JP)

(21) Appl. No.: 13/511,675

(22) PCT Filed: Oct. 22, 2010
(86) PCT No.: PCT/JP2010/068692

§ 371 Date: May 24, 2012

(30) Foreign Application Priority Data
Dec. 3, 2009 (JP) 2009-275646

(51) Int. Cl. G02F 1/13357; F21V 13/04; H04N 5/66; F21V 5/04

(52) U.S. Cl. 348/739; 362/606; 362/607; 362/602; 349/61; 348/E05.133

(57) ABSTRACT

A backlight unit 24 of the present invention includes an LED light source 28, a light guide plate 20 and a lens member 26. The light guide plate 20 is configured to guide light that enters a light entrance surface 20a from the LED light source 28. The light entrance surface 20a has an elongated shape on the side surface thereof. The lens member 26 covers a light exit side of the LED light source 28 and is configured to diffuse light from the LED light source 28. The lens member 26 faces the light entrance surface 20a of the light guide plate 20 and is curved in the long-side direction of the light entrance surface 20a such that the lens member 26 bulges out toward the light guide plate 20 in a convex manner. The lens member 26 spreads light emitted from the LED light source 28 in the long-side direction of the light entrance surface 20a. This reduces a dark portion formed in the light entrance surface of the light guide plate 20.

### TECHNICAL FIELD

The present invention relates to a lighting device, a display device and a television receiver.

### BACKGROUND ART

In recent years, a type of a display element of an image display device including a television receiver has been shifted from a conventional CRT display device to a thin display device using a thin display element such as a liquid crystal panel and a plasma display and a thin image display device is made possible. A liquid crystal panel included in a liquid crystal display device does not emit light, and thus a backlight unit is required as a separate lighting device.

Patent Document 1 discloses a backlight unit including LED light sources, a lens member covering the LED light sources and a light guide plate having an elongated light entrance surface on the side surface thereof. In the backlight unit, the lens member faces the light entrance surface of the light guide plate. The lens member is curved in the short-side direction of the light entrance surface such that the lens member bulges out toward the light guide plate in a convex manner.

Patent Document 1: Japanese Unexamined Patent Publication No. 2009-158274

### Problem to be Solved by the Invention

To miniaturize a lighting device, a distance between light sources and a light guide plate may be shortened. Moreover, to reduce cost for manufacturing light sources, the number of light sources may be decreased. In the backlight unit of the Patent Document 1, the lens member is not curved in the long-side direction of the light entrance surface of the light guide plate. If the distance between the light sources and the light guide plate is shortened and the number of light sources is decreased in the backlight unit of the Patent Document 1, a dark portion may be formed along the long-side direction of the light entrance surface of the light guide plate. Light emitted from the light sources does not enter the dark portion. Therefore, light does not enter the entire surface of the light entrance surface of the light guide plate with uniform brightness.

### DISCLOSURE OF THE PRESENT INVENTION

The present invention was accomplished in view of the above circumstances. It is an object of the present invention to provide a lighting device having a configuration that allows light to enter the entire surface of a light entrance surface of a light guide plate with uniform brightness. Another object of the present invention is to provide a display device having the lighting device and a television receiver having the display device.

### Means for Solving the Problem

To solve the above problem, a lighting device of the present invention includes at least one light source, a light guide plate having an elongated light entrance surface on a side surface thereof and configured to guide light entering the light entrance surface from the at least one light source, and at least one lens member covering a light exit surface of the at least one light source and configured to spread light from the at least one light source, and facing the light entrance surface of the light guide plate. The at least one lens member is curved in a long side direction of the light guide plate so as to bulge out toward the light guide plate in a convex manner.

According to the above lighting device, the lens member spreads light emitted from the light source in the long-side direction of the light entrance surface to reduce a dark portion formed in the light entrance surface of the light guide plate. With such a configuration, even if a distance between the light sources and the light guide plate is short and the number of light sources is small, light enters the entire surface of the light entrance surface of the light guide plate with uniform brightness.

In the lighting device, the at least one lens member may be configured with a cylindrical lens. The at least one lens member may have a cylinder axis extending in a short-side direction of the light entrance surface. With such a configuration, the lens member directs light emitted from the light source uniformly in the long-side direction of the light entrance surface. The light enters a broad range of the light entrance surface. This effectively reduces a dark portion formed in the light entrance surface of the light guide plate.

In the lighting device, the at least one lens member maybe curved in an arc shape. With such a configuration, light emitted from the light source exits in a wide range through the lens member. This effectively reduces a dark portion formed in the light entrance surface of the light guide plate.

The lighting device may further include a first reflection sheet arranged along the long-side direction of the light entrance surface between the at least one light source and the light guide plate. With such a configuration, the first reflection sheet directs light dispersed from the lens member outside the light guide plate back to the light guide plate. This improves the efficiency in directing light emitted from the light source to the light guide plate.

The lighting device may further include a holding member sandwiching at least the at least one light source and the light guide plate. The first reflection sheet may be provided on a part of a surface of the holding member exposed to the light source. With such a configuration, the first reflection sheet may be fixed to the surface of the holding member. This improves the efficiency in directing light emitted from the light source to the light guide plate.

The lighting device may further include a support member having a bottom surface along a plate surface of the light guide plate and configured to support at least the at least one light source and the light guide plate, and a mounting heat sink for mounting the at least one light source on the support member and configured to dissipate heat from the at least one light source. The mounting heat sink may include a first plate portion and a second plate portion. The first plate portion may have a plate surface facing the light entrance surface and the at least one light source may be mounted on the first plate portion. The second plate portion may extend and be curved from the first plate portion. The second plate portion may have a plate surface in the bottom surface direction of the support member and be fixed to the support member. The first reflection sheet may be provided on a part of the surface of the second plate portion exposed to the at least one light source. With such a configuration, the first reflection sheet may be fixed to the surface of the second board portion of the mounting heat sink. This improves the efficiency in directing light emitted from the light source to the light guide plate. Furthermore, the heat sink can reduce heat transferred from the light source to the light guide plate. For example, the light guide plate is less likely to expand with heat.

The lighting device may further include a light source board on which the at least one light source is arranged and a second reflection sheet provided on a surface of the light source board. With such a configuration, the second reflection sheet directs light dispersed from the lens member over the surface of the light source board to the light guide plate. This improves the efficiency in directing light emitted from the light source to the light guide plate.

The lighting device may further include a light source board on which at least one light source is arranged. The light source board may have a surface with a resist applied thereto. The resist may reflect light from the at least one light source. With such a configuration, the resist allows light dispersed from the lens member over the surface of the light source board to be reflected and enter the light guide plate. This improves the efficiency in directing light emitted from the light source to the light guide plate.

In the lighting device, the at least one light source may include a plurality of light sources and arranged in the long-side direction of the light entrance surface. The at least one lens member may include a plurality of lens members covering the light sources, respectively. With such a configuration, if a plurality of light sources is arranged, the lens members spread light emitted from the light sources in the long-side direction of the light guide plate. This reduces a dark portion formed in the light entrance surface of the light guide plate.

In the lighting device, the light exit surface of the at least one lens member may be in contact with the light guide plate. With such a configuration, the light sources and the light guide plate are arranged closely to miniature the lighting device effectively.

The lighting device may further include a diffuser lens provided on the light exit side of the at least one lens member and configured to diffuse light exiting from the at least one lens member. With such a configuration, light emitted from the light sources exits in a broader range through the lens members and the diffuser lenses. This effectively reduces a dark portion formed in the light entrance surface of the light guide plate.

The technology disclosed in the present invention may be described as a display device including a display panel configured to provide display using light from the lighting device. Furthermore, a display device configured to provide the display panel that is a liquid crystal panel using liquid crystal may be new and useful. Furthermore, a television receiver including the display device may be new and useful. The display device and the television receiver realize a large display area.

Advantageous Effect of the Invention

According to the present invention, even if the distance between light sources and a light guide plate is short and the number of light sources is small, light is allowed to enter the entire surface of a light entrance surface of the light guide plate with uniform brightness.

### BRIEF DESCRIPTION OF THE DRAWINGS

FIG. 1 is an exploded perspective view illustrating a general configuration of a television receiver 100 according to a first embodiment of the present invention;

FIG. 2 is a horizontal sectional view schematically illustrating a liquid crystal display device 10;

FIG. 3 is a plan view schematically illustrating a backlight unit 24;

FIG. 4 is a perspective view schematically illustrating an LED unit 32;

FIG. 5 is a perspective view schematically illustrating an LED unit 52 included in the backlight unit according to a second embodiment of the present invention;

FIG. 6 is an enlarged plan view schematically illustrating apart of an LED unit 72 included in the backlight unit according to a third embodiment of the present invention;

FIG. 7 is a plan view schematically illustrating a backlight unit 84 according to a fourth embodiment of the present invention;

FIG. 8 is an exploded perspective view illustrating a liquid crystal display device 110 according to a fifth embodiment of the present invention;

FIG. 9 is a horizontal sectional view illustrating a backlight unit 124; and

FIG. 10 is a horizontal sectional view illustrating the backlight unit 124 according to a sixth embodiment of the present invention.

### BEST MODE FOR CARRYING OUT THE INVENTION

### First Embodiment

Embodiments of the present invention will be described. An X axis, a Y-axis and a Z-axis are described in a part of the drawings, and a direction of each axial direction corresponds to a direction described in each drawing. A Y-axis direction matches a vertical direction and an X-axis direction matches a horizontal direction. Unless otherwise noted, a top to bottom direction will be explained based on a vertical direction.

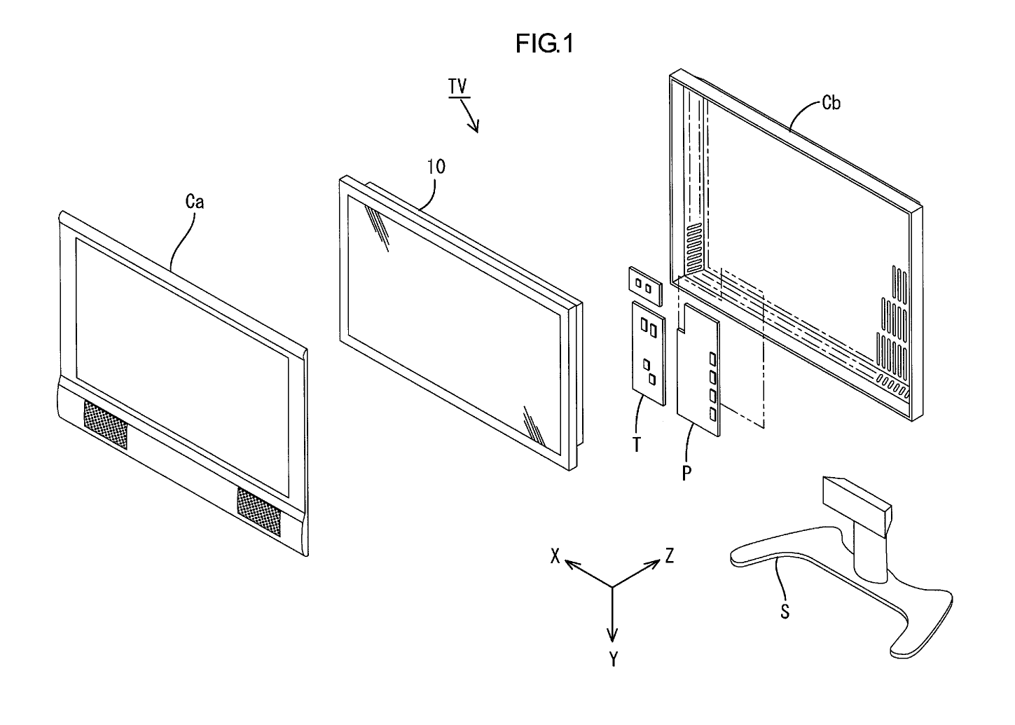

FIG. 1 illustrates an exploded perspective view of a television receiver TV according to a first embodiment of the present invention. As illustrated in FIG. 1, the television receiver TV includes the liquid crystal display device 10, front and rear cabinets Ca, Cb that house the liquid crystal display device 10 therebetween, a power source P, a tuner T and a stand S.

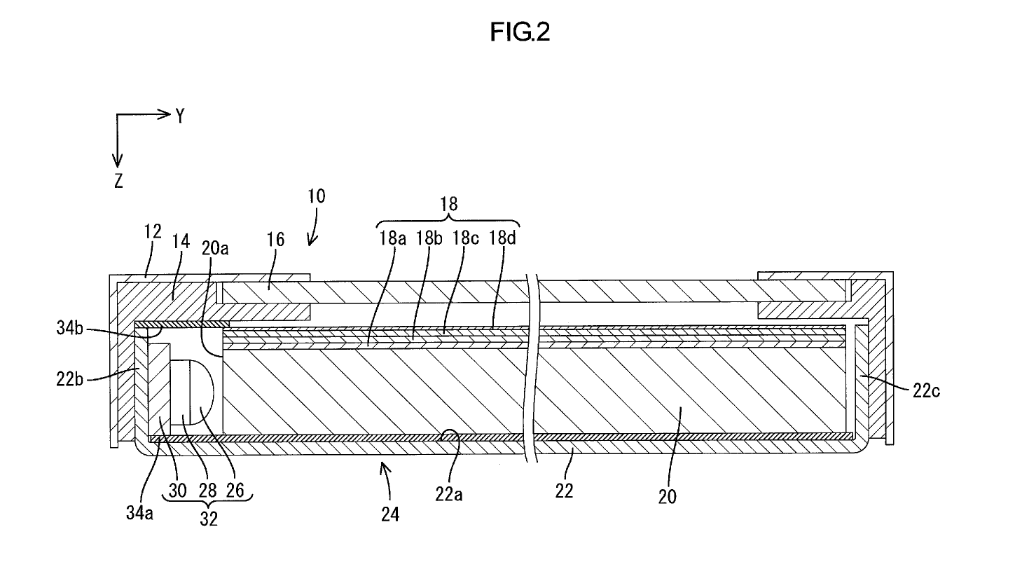

FIG. 2 schematically illustrates a horizontal sectional view of the display device 10. An upper side in FIG. 2 corresponds to a front-surface side and a lower side in FIG. 2 corresponds to a rear-surface side. As illustrated in FIG. 2, an entire shape of the liquid crystal display device 10 is a landscape rectangular. The liquid crystal display device 10 includes a liquid crystal panel 16 as a display panel, and a backlight unit 24 as an external light source. The liquid crystal panel 16 and the backlight unit 24 are integrally held by a frame shaped bezel 12 and the like.

Next, the liquid crystal panel 16 will be described. The liquid crystal panel 16 is configured such that a pair of transparent (highly capable of light transmission) glass substrates is bonded together with a predetermined gap therebetween and a liquid crystal layer (not shown) is sealed between the glass substrates. On one of the glass substrates, switching components (for example, TFTs) connected to source lines and gate lines that are perpendicular to each other, pixel electrodes connected to the switching components, and an alignment film and the like are provided. On the other substrate, color filters having color sections such as R (red), G (green) and B (blue) color sections arranged in a predetermined pattern, counter electrodes, and an alignment film and the like are provided. Polarizing plates are attached to outer surfaces of the substrates. A drive circuit board (not shown) supplies the source lines, the gate lines and counter electrodes with image data and various control signals that are necessary to display images. Polarizing plates (not shown) are attached to outer surfaces of the substrates.

The backlight unit 24 will be described. As illustrated in FIG. 2, the backlight unit 24 includes a backlight chassis 22, optical members 18 and a front chassis 14. The backlight chassis 22 is formed in a substantially box shape opened to the front surface side (the light exit side and the liquid crystal panel 16 side). The optical members 18 are arranged on the front surface side of a light guide plate 20. The frame-shaped front chassis 14 supports the liquid crystal panel 16 along an inner periphery of the front chassis 14. Furthermore, an LED (light emitting diode) unit 32 and the light guide plate 20 are arranged within the backlight chassis 22. The LED unit 32 is provided in one of long-side outer edge portions 22b of the backlight chassis 22 and emits light. One of side surfaces 20a of the light guide plate 20 is provided at a position facing the LED unit 32 to guide light exiting therefrom to the liquid crystal panel 16. The optical members 18 are arranged on the front surface side of the light guide plate 20. In the present embodiment, an edge-light type backlight unit is used for the backlight unit 24. In the backlight unit 24, the light guide plate 20 and the optical members 18 are provided directly below the liquid crystal panel 16 and the LED unit 32 as a light source is provided at the side edge of the light guide plate 20.

The backlight chassis 22 is made of metal such as aluminum material. The backlight chassis 22 includes a rectangular bottom plate 22a in a plan view and side plates 22b and 22c each of which rises from an outer edge of the corresponding side of the bottom plate 22a toward the front surface side. The backlight chassis 22 houses the light guide plate 20 in a space opposite the LED unit 32. A power supply circuit board (not shown) configured to supply power to the LED unit 32 is mounted on the rear side of the bottom plate 22a.

The optical members 18 include laminated layers of a diffuser plate 18a, a diffuser sheet 18b, a lens sheet 18c and a reflecting type polarizing sheet 18d in this order from the light guide plate 20 side. The diffuser sheet 18b, the lens sheet 18c and the reflecting type polarizing sheet 18d have a function for making planar light from light exiting from LED unit 32 and transmitting the diffuser plate 18a therethrough. The liquid crystal panel 16 is provided on the front surface side of the reflecting type polarizing sheet 18d. The optical members 18 are provided between the light guide plate 20 and the liquid crystal panel 16.

The light guide plate 20 formed in a rectangular plate shape is made from a resin highly capable of light transmission (or with high clarity) such as acrylic. As illustrated in FIG. 2, the light guide plate 20 is provided between the LED unit 26 and one of the side plates of the backlight chassis 22. The main plate surface of the light guide plate 20 is provided toward the diffuser plate 18a side. With such a configuration, light generated from the LED unit 26 enters the side plate surface of the light guide plate 20 and exits the main plate surface thereof facing the diffuser plate 18a. Accordingly, the light radiates the liquid crystal panel 12 from the rear side thereof.

Two first reflection sheets 34a and 34b are arranged on the rear surface side and the front surface side of the LED unit 32, respectively. The reflection surfaces of the first refection sheets 34a and 34b are arranged between the LED unit 32 and the light guide plate 20. The first reflection sheet 34a is provided over a surface opposite to a surface facing the diffuser plate 18a of the light guide plate 20 and the rear surface of the LED unit 32. The first reflection sheet 34b is provided on the front surface side of the LED unit 32. Those first reflection sheets 34a and 34b direct light dispersed from a lens member 26 outside the light guide plate 20 back to the light guide plate 20. Furthermore, the first reflection sheets 34a and 34b reflect light leaking out of the light guide plate 20 back to the light guide plate 20. The LED unit 32 will be described in detail later with reference to other drawings.

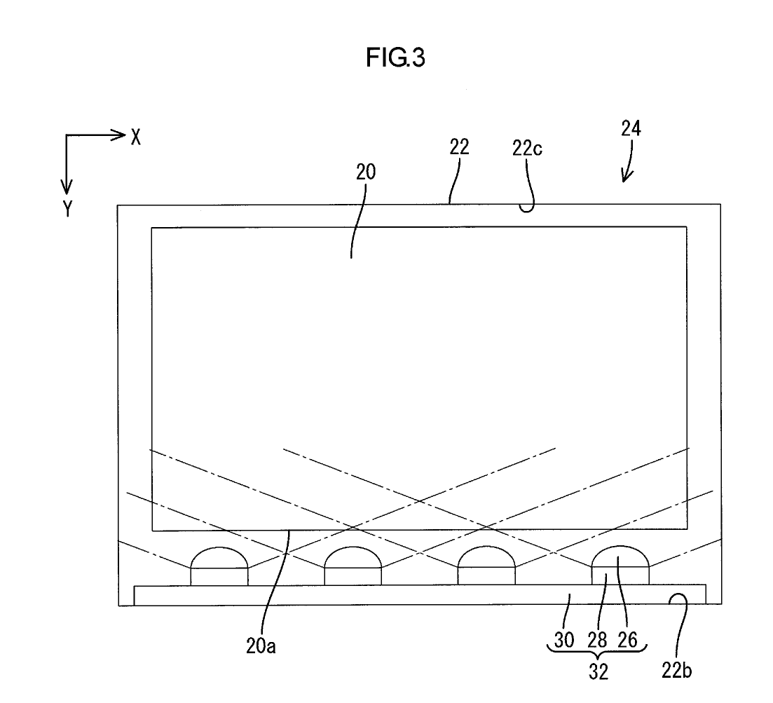

FIG. 3 illustrates a schematic plan view of the backlight unit 24. FIG. 3 only illustrates the backlight chassis 22, the light guide plate 20 and the LED unit 32. Other members or portions are not illustrated in FIG. 3. Dashed-dotted lines in FIG. 3 show paths of rays of light exiting from the LED unit 32.

As illustrated in FIG. 3, the LED unit 32 includes an LED board 30, LED light sources 28 and lens members 26. The rectangular LED board 30 is made from resin. The LED light sources 28 configured to emit white light are arranged linearly in a line on the LED board 30. Each lens member 26 covers a light exit surface of the LED light source 28. Each lens member 26 faces the light entrance surface 20a of the light guide plate 20 and is curved in the long-side direction of the light entrance surface 20a such that each lens member 26 bulges out toward the light guide plate 20 in a convex manner. The lens members 26 diffuse light emitted from the LED light sources 28 in the long-side direction of the light entrance surface 20a. The LED unit 32 is mounted on the long-side outer edge portion 22b, which is one of the long-side outer edge portions of the backlight chassis 22, with screws and the like such that the lens members 26 face the light entrance surface 20a of the light guide plate 20.

As illustrated in FIG. 3, light emitted from the

LED light sources 28 is spread out in the long-side direction of the light entrance surface 20a through the lens members 26 to enter the entire light entrance surface 20a uniformly.

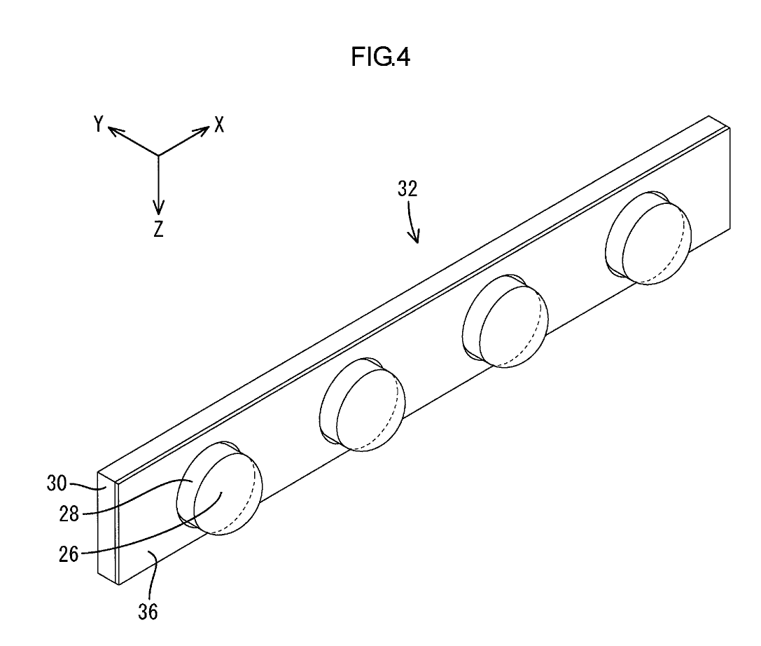

FIG. 4 illustrates a schematic perspective view of the LED unit 32. As illustrated in FIG. 4, the lens member 26 covering the light exit side of the LED light source 28 is formed in a hemispherical shape. A second reflection sheet 36 is provided in a portion of the surface of the LED board 30 in which the LED light sources 28 are not provided. The second reflection sheet 36 directs light dispersed from the lens member 26 over the surface of the LED board 30 to the light guide plate 20.

The television receiver TV of the present embodiment has been described in detail. In the backlight unit 24 of the television receiver TV according to the present embodiment, the lens members 26 spreads light that is emitted from the LED light sources 28 in the long-side direction of the light entrance surface 20a. This reduces a dark portion formed in the light entrance surface 20a of the light guide plate 20. Namely, if the distance between the LED light sources 28 and the light guide plate 20 is short and the number of the LED light sources is small, light enters the entire light entrance surface 20a of the light guide plate 20 with uniform brightness.

In the present embodiment, the lens member 26 is formed in a hemispherical shape and curved like an arc. Accordingly, the lens member 26 allows light emitted from the LED light source 28 to exit in a broad range.

In the present embodiment, the first reflection sheets 34a and 34b are provided in the long-side direction of the light entrance surface 20a between the LED light sources 28 and the light guide plate 20. The first reflection sheets 34a and 34b improve the efficiency in directing light emitted from the LED light sources 28 to the light guide plate 20.

In the present embodiment, each lens member 26 covers each LED light source 28. With such a configuration, lens members 26 each disperse light emitted from the LED light sources 28 in the long-side direction of the light entrance surface 20a.

### Second Embodiment

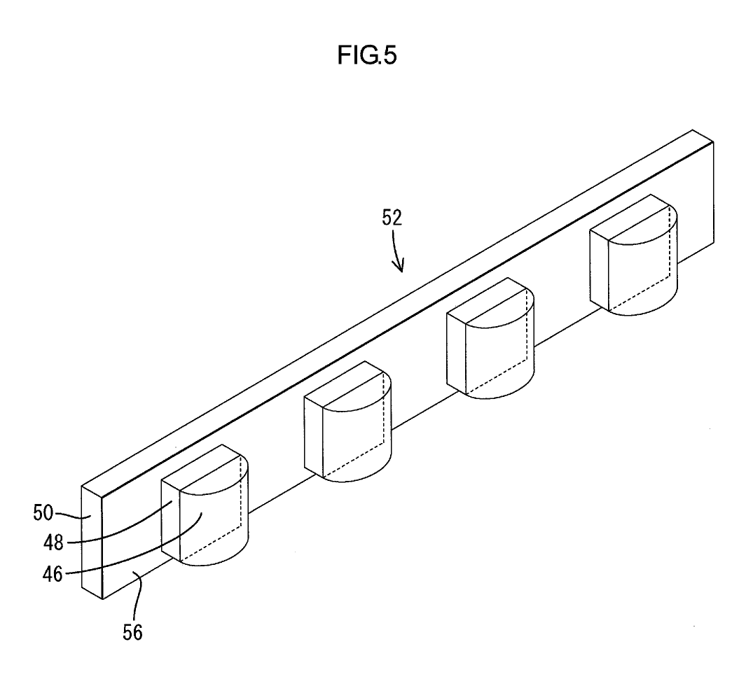

FIG. 5 illustrates a schematic perspective view of an LED unit 52 in the backlight unit according to a second embodiment of the present invention. The second embodiment is different from the first embodiment in a shape of an LED light source 48 and a lens member 46. The construction, operations and effects as same as the first embodiment will not be explained.

In the backlight unit of the second embodiment, the LED light source 48 is formed in a rectangular shape with a plan view and the lens member 46 covers the surface (the light exit side) of the LED light source 48. The lens member 46 is configured with a cylindrical lens. As illustrated in FIG. 5, a cylinder axis of the lens member 46 extends in the short direction (in the Z-axis direction in the figure) of a light entrance surface of a light guide plate. The lens member 46 allows light emitted from the LED light source 48 to exit uniformly in the long-side direction of the light entrance surface of the light guide plate to enter a broad range of the light entrance surface. This effectively reduces a dark portion formed in the light entrance surface of the light guide plate.

A white resist 56 is applied to a part of the surface of an LED board 50 in which the LED light sources 48 are not provided. The resist 56 reflects light from the LED light source 48. The resist 56 reflects light dispersed by the lens member 46 over the surface of the LED board 50 and directs the light to the light guide plate. This improves the efficiency in directing light emitted from the LED light sources 50 to the light guide plate.

### Third Embodiment

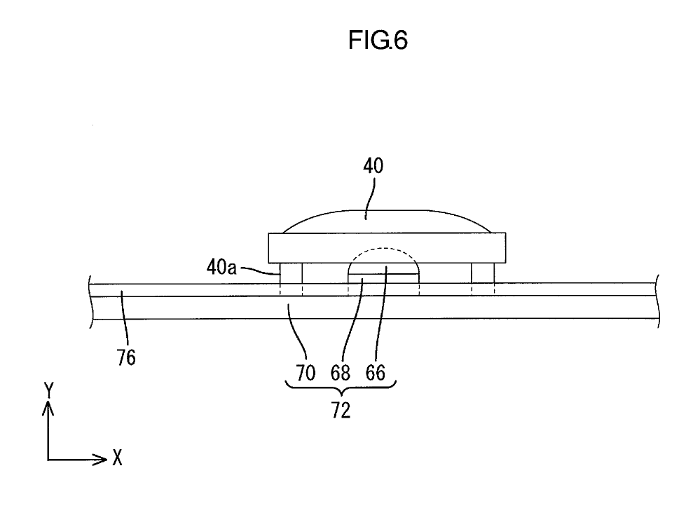

FIG. 6 illustrates a schematic enlarged plan view of a part of an LED unit 72 in the backlight unit according to a third embodiment of the present invention. The third embodiment is different from the first embodiment in that the backlight unit includes a diffuser lens 40. The construction, operations and effects that are same as the first embodiment will not be explained.

In the backlight unit in the third embodiment, a diffuser lens 40 is provided on the light exit side of the lens member 66. The diffuser lens 40 configured to diffuse light exiting from the lens member 66 is supported on an LED board 70 by a support portion 40a. The diffuser lens 40 is provided on the light exit side of the lens member 66, and accordingly, light emitted from the LED light source 68 exits in a broader range through the lens member 66 and the diffuser lens 40. This effectively reduces a dark portion formed in the light entrance surface of the light guide plate.

### Fourth Embodiment

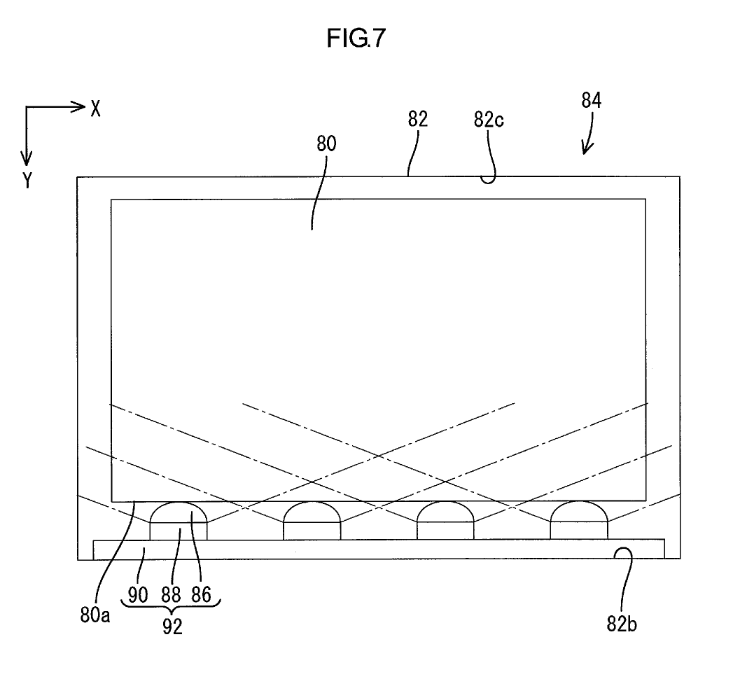

FIG. 7 illustrates a schematic plan view of a backlight unit 84 according to a fourth embodiment of the present invention. The fourth embodiment is different from the first embodiment in a distance between a lens member 86 and a light guide plate 80. The construction, operations and effects that are same as the first embodiment will not be explained. Dashed-dotted lines in FIG. 7 represent paths of rays of light exiting from an LED unit 92.

In the backlight unit 84 of the fourth embodiment, a surface of the lens member 86 is in contact with a light entrance surface 80a of the light guide plate 80. As illustrated in the dash-dotted lines in FIG. 7, the lens members 86 spread light emitted from the LED light sources 88 in the long-side direction of the light entrance surface 80a. With this configuration, light enters the entire light entrance surface 80a of the light guide plate 80 with uniform brightness. Furthermore, the LED light sources 88 are arranged closely to the light guide plate 80. This allows a backlight chassis to make smaller, thereby miniaturizing the backlight unit 84.

### Fifth Embodiment

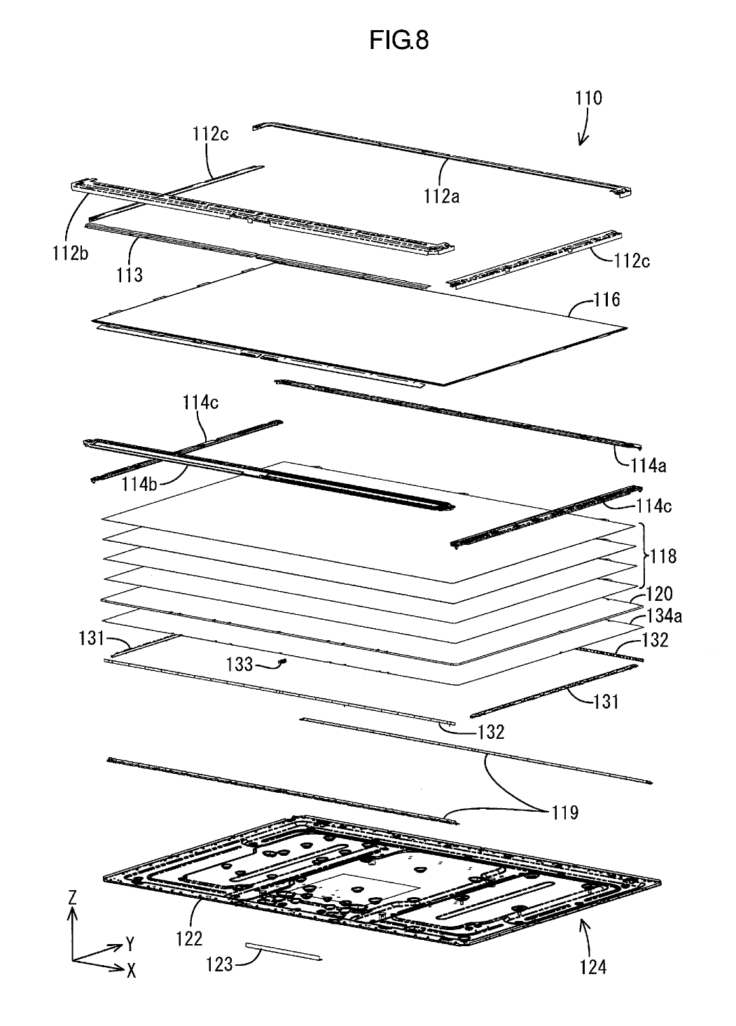

FIG. 8 illustrates an exploded perspective view of a liquid crystal display device 110 according to a fifth embodiment of the present invention. An upper side in FIG. 8 corresponds to a front-surface side and a lower side in FIG. 8 corresponds to a rear-surface side. An entire shape of the liquid crystal display device 110 is a landscape rectangular. As illustrated in FIG. 8, the liquid crystal display device 110 includes a liquid crystal panel 116 as a display panel, and a backlight unit 124 as an external light source. The liquid crystal panel 116 and the backlight unit 124 are integrally held by a top bezel 112a, a bottom bezel 112b, side bezels 112c (hereinafter a bezel set 112a to 112c) and the like. The construction of the liquid crystal panel 116 that is as same as the first embodiment will not be explained.

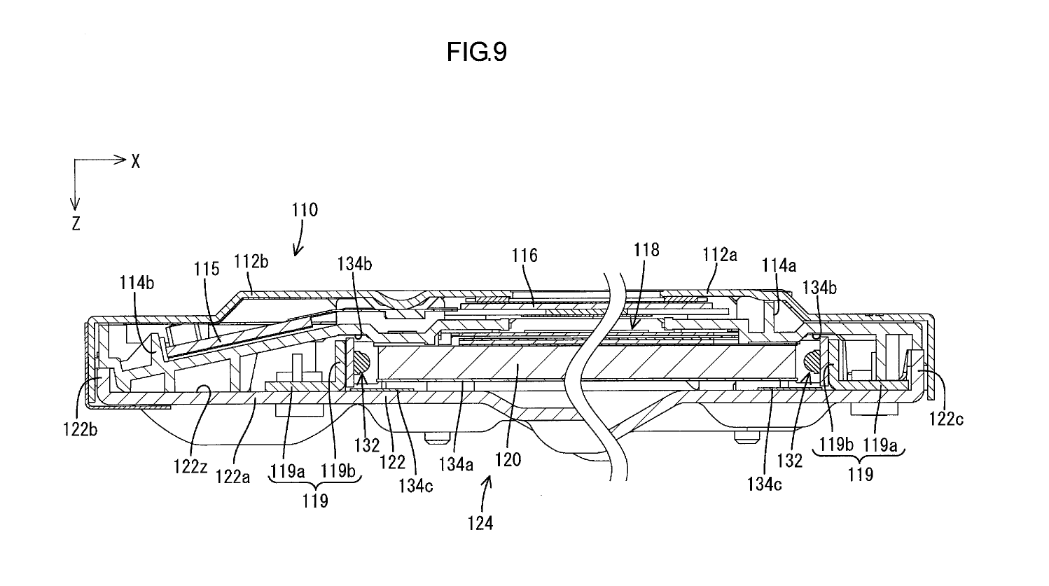

In the following, the backlight unit 124 will be explained. As illustrated in FIG. 8, the backlight unit 124 includes a backlight chassis (a holding member and support member) 122, optical members 118, a top frame (a holding member) 114a, a bottom frame (holding member) 114b, side frames (holding member) 114c (hereinafter a frame set 114a to 114c) and a reflection sheet 134a. The liquid crystal panel 116 is sandwiched between the bezel set 112a to 112c and the frame set 114a to 114c. A reference numeral 113 represents an insulating layer configured to insulate a driving circuit board 115 (see FIG. 9) for driving the liquid crystal panel. The substantially box-shaped backlight chassis 122 has an opening on the front-surface side (on the light exit side and the liquid crystal panel 116 side). The optical members 118 are provided on the front-surface side of the light guide plate 120. The reflection sheet 134a is provided on the rear-surface side of the light guide plate 120. Furthermore, the backlight chassis 122 houses a pair of cable holders 131, a pair of heat sinks (mounting heat sinks) 119, a pair of LED units 132 and a light guide plate 120 in the backlight chassis 122. The LED units 132, the light guide plate 120 and the reflection sheet 134a are supported each other by a rubber bushing 133. A power supply circuit board (not shown) configured to supply power to the LED units 132 and a protection cover 123 for protecting the power supply circuit board are mounted on the rear side of the backlight chassis 122. The pair of cable holders 131 is arranged in the short-side direction of the backlight chassis 122 and holds cables electrically connected between the LED units 132 and the power supply circuit board.

FIG. 9 illustrates a horizontal sectional view of the backlight unit 124. As illustrated in FIG. 9, the backlight chassis 122 includes a bottom plate 122a having the bottom surface 122z thereon and side plates 122b and 122c each of which rises shallowly from an outer edge of the corresponding side of the bottom plate 122a. The backlight chassis 122 supports at least the LED units 132 and the light guide plate 120. Furthermore, the pair of heat sinks 119 includes bottom surface portions (second plate portions) 119a and side surface portions (first plate portions) 119b each of which rises from outer edges of the long side of the bottom surface portions 119a. Each heat sink 119 is formed in an L-shape with a horizontal sectional view and provided in both long-side directions of the backlight chassis 122. The bottom surface portions 119a of the heat sinks 119 are fixed to the bottom plate 122a of the backlight chassis 122. The LED units 132 in the pair extend along respective long sides of the backlight chassis 122. The LED units 132 are individually fixed to the side surface portions 119b of the heat sinks 119 such that the light exit sides of the LED units 132 face each other. Accordingly, the bottom plate 122a of the backlight chassis 122 supports the pair of LED units 132 individually through the heat sinks 119. The heat sinks 119 dissipate heat generated in the LED units 132 outside the backlight unit 124 through the bottom plate 122a of the backlight chassis 122.

As illustrated in FIG. 9, the light guide plate 120 is provided between the pair of LED units 132. The frame set (first holding member) 114a to 114c and the backlight chassis (second holding member) 122 sandwich the pair of LED units 132, the light guide plate 120 and the optical members 118. Furthermore, the frame set 114a to 114c and the backlight chassis 122 fix the light guide plate 120 and the optical members 118. The construction of the LED units 132, the light guide plate 120 and the optical members 118 that is as same as the first embodiment will not be explained. An edge light type (side light type) is used for the backlight unit 124 of the present embodiment. The present embodiment is different from the first embodiment in that the LED units 132 are provided at the edges of both sides of the light guide plate 120.

As illustrated in FIG. 9, the driving circuit board 115 is provided on the front-surface side of the bottom frame 114b. The driving circuit board 115 is electrically connected to the display panel 116 to supply image data and various control signals that are necessary to display images with the display panel 116. First reflection sheets 134b are arranged in the long-side direction of the light guide plate 120. One of the first reflection sheets 134b is provided on apart of the surface of the top frame 114a exposed to one of the LED units 132. The other first reflection sheet 134b is provided on a part of the surface of the bottom frame 114b facing the other LED unit 132.

In the backlight unit 124 of the present embodiment, one of the first reflection sheets 134b is fixed to the surface of the top frame 114a. Furthermore, the other first reflection sheet 134b is fixed to the surface of the bottom frame 114b. This improves the efficiency in directing light exiting from the LED units 132 to the light guide plate 120.

### Sixth Embodiment

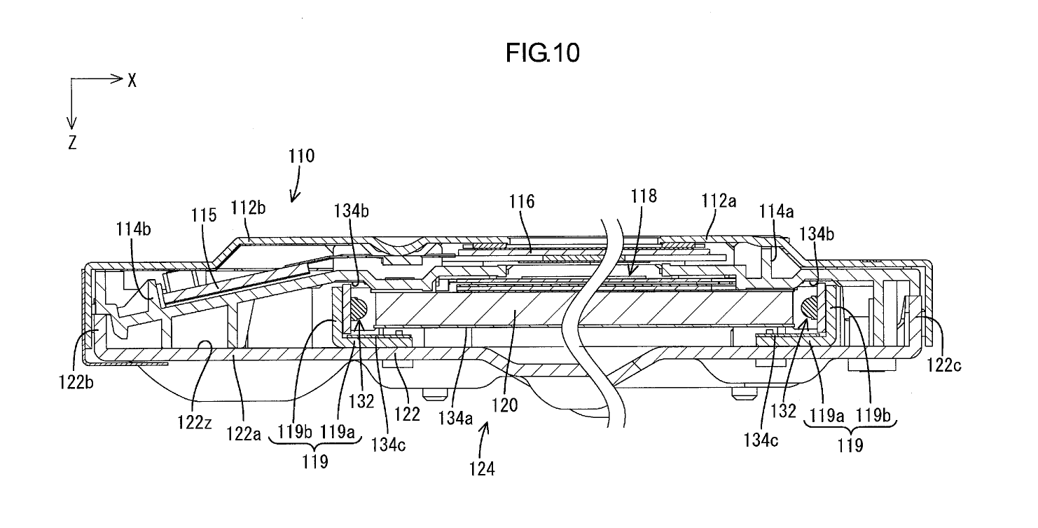

FIG. 10 illustrates a horizontal sectional view of a backlight unit 124 according to a sixth embodiment of the present invention. The sixth embodiment is different from the fifth embodiment in arrangement and a shape of the heat sinks 119. The construction, operations and effects that are same as the fifth embodiment will not be explained.

In the backlight unit 124 of the sixth embodiment, the heat sinks 119 are arranged on the bottom plate 122a of the backlight chassis 122 such that the bottom surface portions (second plate portions) 119a of the heat sinks 119 are provided between the LED units 132 and the light guide plate 120. First reflection sheets 134c are provided in the long-side direction of the light guide plate 120. The first reflection sheets 134c are provided in portions that are the bottom surface portion 119a of the heat sinks 119 and that are exposed to the LED units 132.

In the backlight unit 124 of the present embodiment, the first reflection sheets 134c are fixed to the surface of the heat sinks 119. This improves the efficiency in directing light exiting from the LED units 132 to the light guide plate 120. Furthermore, the heat sinks 119 can reduce heat transferred from the LED units 132 to the light guide plate 120. For example, the light guide plate 120 is less likely to thermally expand.

Correspondence relationships between the construction of the embodiments and the construction of the present invention will be described. The LED light sources 28, 48, 68 and 88 are an example of a “light source.” The backlight units 24 and 84 are an example of a “lighting device.” The LED boards 30, 50, 70, 90 are an example of a “light source board.”

In the following, modifications of the above embodiments will be explained.

(1) In the above embodiments, the LED light source emitting white light is mounted. However, three types of LED light sources such as emitting red light, green light and blue light, may be mounted on a plane. A combination of an LED light source emitting blue light and a yellow fluorescent material may be mounted.

(2) In the above embodiments, the LED units are provided in only one of the long-side outer edge portions of the backlight chassis. However, the LED units may be provided in both of the long-side outer edge portions.

(3) In the above embodiments, one lens member covers one LED light source. However, one lens member may cover multiple LED light sources.

(4) In the above embodiments, the lens member is curved like an arc in the long-side direction of the light entrance surface. However, the surface of the lens member may be formed into a polygonal shape in the long-side direction of the light entrance surface.

(5) The arrangement and the shape of lens member may be altered if necessary.

(6) In the above embodiments, the liquid crystal display device including the liquid crystal panel as a display panel. The technology can be applied to display devices including other types of display components.

(7) In the above embodiments, the television receiver including the tuner is used. However, the technology can be applied to a display device without a tuner.

The embodiments of the present invention have been described in detail. The embodiments are for illustrative purposes only and by no means limit the scope of the present invention. Technologies described in the present invention include variations and modifications of the embodiments and examples described above.

The technical elements described or shown in the specification or drawings exhibit the technical usefulness individually or in various combinations thereof. The technical elements are not limited to the combinations defined in the claims at the time of filing the application. Furthermore, the technologies illustrated in the specification or drawings realize a plurality of purposes at the same time and have a technical usefulness when one of the purposes is realized.

### EXPLANATION OF SYMBOLS

TV: television receiver, Ca, Cb: cabinet, T: tuner, S: stand, 10, 110: liquid crystal display device, 12: bezel, 14: front chassis, 16, 116: liquid crystal panel, 18, 118: optical member, 18a: diffuser plate, 18b: diffuser sheet, 18c: lens sheet, 18d: the reflecting type polarizing sheet, 20, 80, 120: light guide plate, 22, 122: backlight chassis, 22a, 122a: bottom plate, 22b, 22c, 122b, 122c: side plate (long-side outer edge portion), 24, 84, 124: backlight unit, 26, 46, 66, 86: lens member, 28, 48, 68, 88: LED light source, 30, 50, 70, 90: LED board, 32, 52, 72, 132: LED unit, 34a, 34b, 134b: first reflection sheet, 36, 134c: second reflection sheet, 40: diffuser lens, 40a: support portion, 56: resist, 112a: top bezel, 112b: a bottom bezel, 112c: a side bezel, 114a: top front chassis, 114b: bottom front chassis, 114c: side front chassis, 115: driving circuit board, 119: heat sink, 123: protection cover, 131: cable holder, 133: rubber bushing, 134a: reflection sheet

1. A lighting device comprising:
at least one light source;
a light guide plate having an elongated light entrance surface on a side surface thereof and configured to guide light entering the light entrance surface from the at least one light source; and
at least one lens member covering a light exit surface of the at least one light source and configured to spread light from the at least one light source, and facing the light entrance surface of the light guide plate, the at least one lens member being curved in a long side direction of the light guide plate so as to bulge out toward the light guide plate in a convex manner.

2. The lighting device according to claim 1, wherein:
the at least one lens member is configured with a cylindrical lens; and
the at least one lens member has a cylinder axis extending in a short side direction of the light entrance surface.

3. The lighting device according to claim 1, wherein the at least one lens member is curved in an arc shape.

4. The lighting device according to claim 1, further comprising a first reflection sheet arranged along the long side direction of the light entrance surface between the at least one light source and the light guide plate.

5. The lighting device according to claim 4, further comprising a holding member holding at least the at least one light source and the light guide plate,
wherein the first reflection sheet is provided on a part of a surface of the holding member exposed to the light source.

6. The lighting device according to claim 4, further comprising:
a support member having a bottom surface along a plate surface of the light guide plate and configured to support at least the at least one light source and the light guide plate; and
a mounting heat sink for mounting the at least one light source on the support member and configured to dissipate heat from the at least one light source, wherein:
the mounting heat sink includes a first plate portion and a second plate portion, the first plate portion having a plate surface facing the light entrance surface and on which the at least one light source is mounted, the second plate portion extending and curved from the first plate portion, having a plate surface in the bottom surface direction of the support member and fixed to the support member; and
the first reflection sheet is provided on a part of the surface of the second plate portion exposed to the at least one light source.

7. The lighting device according to claim 1, further comprising:
a light source board on which the at least one light source is arranged; and
a second reflection sheet provided on a surface of the light source board.

8. The lighting device according to claim 1, further comprising a light source board on which at least one light source is arranged, the light source board having a surface with a resist applied thereto, the resist reflecting light from the at least one light source.

9. The lighting device according to claim 1, wherein:
the at least one light source includes a plurality of light sources arranged in the long side direction of the light entrance surface; and
the at least one lens member includes a plurality of lens members covering the light sources, respectively.

10. The lighting device according to claim 1, wherein the light exit surface of the at least one lens member is in contact with the light guide plate.

11. The lighting device according to claim 1, further comprising a diffuser lens provided on the light exit side of the at least one lens member and configured to diffuse light exiting from the at least one lens member.

12. A display device comprising:
the lighting device according to claim 1; and
a display panel configured to provide display using light from the lighting device.

13. The display device according to claim 12, wherein the display panel is a liquid crystal panel using liquid crystals.

14. A television receiver comprising the display device according to claim 12.
